(19) United States
(12) Patent Application Publication
(10) Pub. No.: US 2010/0057227 A1
(43) Pub. Date: Mar. 4, 2010

(54) ELECTRONIC APPLIANCE FOR TRIGGERING AUDIO SIGNALS AS WELL AS CORRESPONDING COMPUTER PROGRAMME AND CORRESPONDING COMPUTER-READABLE STORAGE MEDIUM

(75) Inventor: Herbert Jünger, Beline (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: Junger Audio-Studiotechnik GMBH, Berlin (DE)

(21) Appl. No.: 12/063,158

(22) PCT Filed: Jun. 13, 2006
(86) PCT No.: PCT/EP2006/063155

§ 371 Date: Nov. 20, 2009

(30) Foreign Application Priority Data
Aug. 8, 2005 (DE) 20 2005 012 816.3

(51) Int. Cl. G06F 17/00

(52) U.S. Cl. 700/94

(57) ABSTRACT

An electronic system for modulating audio signals and operating based on a digital signal processing is disclosed. The electronic device includes at least one means for monitoring the parameters operating level and peak level of the audio signal and for automatically adjusting the operating level of the audio signal. Also disclosed is a corresponding computer program for modulating audio signals and a corresponding computer-readable storage medium for storing the computer program.

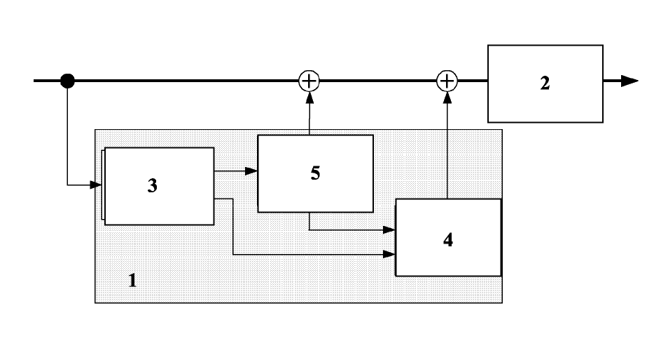

The invention is directed to an electronic device for modulating audio signals based on digital signal processing, as well as a corresponding computer program and a corresponding computer-readable storage medium, which can be used, in particular, in audio and television studios in the radio and television industry, as well as for audio processing in cable feed stations and satellite uplink stations for radio and television.

Devices for these applications used to date include essentially an automatic level control (AGC=Automatic Gain Control) and a limiting unit (Limiter, Clipper). However, undesirable changes in the audio signal due to the AGC and the clipper function can be expected.

It is therefore an object of the invention to provide an electronic device for modulating audio signals, as well as a corresponding computer program and a corresponding computer-readable storage medium, which eliminates the undesirable changes in the audio signal and, more particularly, permanently controls the modulation of the audio signal.

The object is attained with the invention by the features recited in the claims 1, 7, and 8. Advantageous embodiments of the invention are recited in the dependent claims.

The electronic device of the invention has the particular advantage that the signal level can be controlled over a longer time period, without adversely affecting the operating level of the audio signal, while also controlling the level of transient components of the audio signal. This is attained by employing an electronic device for modulating audio signals on the basis of digital signal processing, wherein the electronic device includes at least one means for monitoring the audio signal with respect to the parameters operating level and peak level, and for automatically adjusting the operating level of the audio signal.

In a preferred embodiment of the electronic device of the invention, the at least one means is configured such that the audio signal for automatic adjustment of the operating level is monitored at each point in time with respect to the parameters operating level and peak level. Preferably, the at least one means is configured such that the operating level and the peak level are monitored concurrently. Alternatively or in addition, the at least one means is configured such that the operating level and the peak level are monitoring permanently and/or the operating level of the audio signal is adjusted continuously and automatically.

According to another preferred embodiment of the device for modulating audio signals, the electronic device includes a first functional unit for controlling the modulation of audio signals and a second functional unit for controlling the peak level.

Advantageously, the first functional unit includes at least one first sub-functional unit for determining the level of the audio signal, at least one second sub-functional unit for regulating the level of the audio signals, and at least one third sub-functional unit for regulating transient components of the audio signal, wherein a signal input of the first sub-functional unit is connected with a signal input of the first functional unit, wherein a signal output of the first sub-functional unit is connected with a signal input of the second sub-functional unit and with a signal input of the third sub-functional unit, wherein a signal output of the third sub-functional unit is connected with a signal input of the second sub-functional unit, and wherein respective signal outputs of the second and the third sub-functional unit are each connected with a corresponding signal output of the first functional unit. In particular, the circuit arrangement of the two second and third sub-functional units Automatic Gain Control and Transient Processor, respectively, enables simultaneous control of both the level of the audio signals and of the level of transient components of the audio signal.

As an alternative to monitoring the operating level and peak level of audio signals with hardware and to automatically adjusting the operating level of the audio signal, the audio signals can also be modulated by employing a computer program, which enables a data processing system, after the computer program is loaded into memory of the data processing system, to modulate the audio signals based on digital signal processing, wherein an operating level and a peak level of the audio signal are monitored simultaneously and the operating level of the audio signal is automatically adjusted.

For example, the computer programs according to the invention can be provided (fee-based or free of charge, freely accessible or password-protected) in a data or communication network for downloading. The provided computer programs can be used with a method, wherein a computer program according to claim 6 is downloaded from an electronic data network, for example from the Internet, to a data processing system connected to the data network.

For modulating audio signals, a computer readable storage medium with a stored program can advantageously be employed, with the program enabling a data processing system, after the computer program is loaded into memory of the data processing system, to modulate audio signals based on digital signal processing, wherein an operating level and a peak level of the audio signal are monitored simultaneously and the operating level of the audio signal is automatically adjusted.

The invention will be described hereinafter in more detail with reference to the sole figure which shows a schematic block diagram of an exemplary embodiment of the device according to the invention for modulating audio signals.

The device includes a first functional unit 1 for controlling the modulation of audio signals (Audio Leveller), which is connected to a downstream second functional unit 2 which controls the peak level (Brickwall Limiter). The level of the audio signal to be processed in this way is then permanently regulated by these two functional units 1, 2. The sub-functions (sub-functional units) AGC 4 and Transient Processor 5 make use of a common sub-function (sub-functional unit) level detection 3. The three sub-functional units 3, 4, and 5 are preferably implemented in hardware; alternatively, the three sub-functions can also be implemented in software.

This configuration of the Audio Leveller 1 according to the invention makes it possible for the first time to control concurrently and permanently both the level of the signal over a longer period of time and the level of transient components of the audio signal, without causing undesirable effects for the operating level of the audio signal. The downstream Brickwall Limiter 2 limits any peaks in the audio signal without introducing distortion and without exceeding the set threshold value for the Limiter.

The operation of the functional units Audio Leveller 1, Brickwall Limiter 2, and the operation of the sub-functions Limit Detection 3, AGC 4 and Transient Processor 5 are characterized by automatically executed adaptive algorithms which makes the functions simple to use.

The invention can be applied in various device implementations by using the aforedescribed functional units 1 (Audio Leveller) and 2 (Brickwall Limiter), without deviating from the scope of the invention.

### LIST OF REFERENCE SYMBOLS

1 First functional unit for controlling the modulation of audio signals, Audio Leveller

2 Second functional unit for controlling the peak level, Brickwall Limiter

3 First sub-functional unit for determining the level of the audio signal, Level Detection

4 Second sub-functional unit for controlling the level of the audio signal, Automatic Gain Control (AGU)

5 Third sub-functional unit for controlling transient components of the audio signal, Transient Processor

1. Electronic device for modulating audio signals based on digital signal processing, wherein the electronic device includes at least one means for monitoring the audio signal with respect to the parameters operating level and peak level and for automatically adjusting the operating level of the audio signal.

2. Electronic device according to claim 1, wherein the at least one means is configured such that the audio signal for automatic adjustment of the operating level is monitored at each point in time with respect to the parameters operating level and peak level.

3. Electronic device according to claim 1, wherein the at least one means is configured such that monitoring of the operating level and peak level are performed concurrently.

4. Electronic device according to claim 1, wherein the at least one means is configured such that monitoring of the operating level and of the peak level is performed permanently and/or the automatic adjustment of the operating level of the audio signal is performed continuously.

5. Electronic device according to claim 1, wherein the electronic device comprises a first functional unit (1) for controlling the modulation of audio signals and a second functional unit (2) for controlling the peak level.

6. Electronic device according to claim 5, wherein the first functional unit (1) includes at least one first sub-functional unit (3) for determining the level of the audio signal, at least one second sub-functional unit (4) for regulating the level of the audio signals, and at least one third sub-functional unit (5) for regulating transient components of the audio signal, wherein a signal input of the first sub-functional unit (3) is connected with a signal input of the first functional unit (1), wherein a signal output of the first sub-functional unit (3) is connected with a signal input of the second (4) and with a signal input of the third sub-functional unit (5), wherein a signal output of the third sub-functional unit (5) is connected with a signal input of the second sub-functional unit (4), and wherein respective signal outputs of the second (4) and the third sub-functional unit (5) are each connected with a corresponding signal output of the first functional unit (1).

7. Computer program which enables a data processing system, after the computer program is loaded into memory of the data processing system, to perform a modulation of audio signals based on digital signal processing, wherein an operating level and a peak level of the audio signal are monitored simultaneously and the operating level of the audio signal is automatically adjusted.

8. Computer-readable storage medium having stored thereon a program which enables a data processing system, after the computer program is loaded into memory of the data processing system, to perform a modulation of audio signals based on digital signal processing, wherein an operating level and a peak level of the audio signal are monitored simultaneously and the operating level of the audio signal is automatically adjusted.
